(19) United States
(12) Patent Application Publication
(10) Pub. No.: US 2020/0167435 A1
(43) Pub. Date: May 28, 2020

(54) SYNCHRONOUS OPERATION DISPLAY SYSTEM AND NON-TRANSITORY COMPUTER READABLE MEDIUM

(71) Applicants: Inventec (Pudong) Technology Corporation, Shanghai (CN); INVENTEC CORPORATION, Taipei City (TW)

(72) Inventors: Cheng-Hsin CHEN, TAIPEI CITY (TW); Chun-Hung LIN, TAIPEI CITY (TW)

(21) Appl. No.: 16/408,487

(22) Filed: May 10, 2019

(30) Foreign Application Priority Data
Nov. 26, 2018 (CN) 201811416518.8

(51) Int. Cl. G06F 17/50; G06F 3/0481; G06F 3/0484; G06F 3/14

(52) U.S. Cl. CPC G06F 17/50; G06F 3/0481; G06F 2203/04803; G06F 3/14; G06F 2217/02; G06F 3/04842

(57) ABSTRACT

A system for synchronous operation display is operated in at least one computer. The system for synchronous operation display includes an input/output (I/O) device, a memory, and a processor. The I/O device is configured to display a screen and receive an operation input. The memory store includes computer code, application programs, and files. The processor is coupled to the I/O device and the memory. The processor is configured to execute the computer program code, in order to provide an object design screen, and display the design specification in the corresponding window.

### CROSS-REFERENCE TO RELATED APPLICATION

This application claims priority to China Application Serial Number 201811416518.8, filed Nov. 26, 2018, which is herein incorporated by reference in its entirety.

### BACKGROUND

### Technical Field

The present disclosure relates to a synchronous operation display system and a non-transitory computer readable medium, and in particular to a display system for simultaneous operation of files and applications.

### Description of Related Art

When a user makes designs for objects via an application program, it generally requires studying relevant guidelines, manuals, and specified chapters thereof at first, in order to make the designs via the application program with reference to related designing parameters or methods. However, most of the design guidelines and manuals only list the formulas or parameters that may be used in the design and the schematic diagrams of the applications without showing actual results. Therefore, when engineers study these materiel, the engineers are only able to manually copy formulas or data into the application program, resulting in waste of time.

### SUMMARY

In order to solve the above problems, a synchronous operation display system is disclosed which operates in at least one computer. The synchronous operation display system comprising: at least one input/output device configured to display a picture and receive at least one command; a memory configured to store at least one computer code, an application program, and a file; and a processor coupled to the at least one input/output device and the memory, the processor configured to execute at least one computer code, in order to: open the application program to provide a design screen of an object, wherein the design screen comprises a first component and a second component to be designed of the object, the first component is required to meet a first design specification, and the second component is required to meet a second design specification that is different from the first design specification; display a corresponding window that displays the first design specification when an operation indicator is detected to be adjacent to the first component in the design screen; and display the corresponding window that displays the second design specification when the operation indicator is detected to be adjacent to the second component in the design screen.

In some embodiments, wherein the first design specification comprises a current design scheme and at least one candidate design that are corresponding to the first component.

In some embodiments, wherein when the operation indicator in the corresponding window points to the candidate design, and the processor is further configured to instantly apply a formula and parameters of the candidate design scheme to the object, in order to run a simulation of the object and provide a preview display of the simulation.

In some embodiments, wherein when the corresponding window receives a command that is for switching from the current design scheme to the candidate design scheme, and the first component is adjusted in the design screen to meet the candidate design scheme.

In some embodiments, wherein the preview display presents changes between before and after the object is applied with the candidate design scheme by a graph or a chart.

In some embodiments, wherein the first design specification comprises a plurality of chapters and pages that illustrate the current design scheme and the candidate design scheme.

A non-transitory computer readable medium comprises a computer program instruction, when a processor executes the computer program instruction, causing the processor to perform the following operations: open an application program for providing a design screen of an object, wherein the design screen comprises a first component and a second component to be designed of the object, the first component is required to meet a first design specification, and the second component is required to meet a second design specification that is different from the first design specification; display a corresponding window that displays the second design specification when an operation indicator is detected to be adjacent to the first component in the design screen; and display the corresponding window that displays the second design specification when the operation indicator is detected to be adjacent to the second component in the design screen.

In some embodiments, wherein the first design specification comprises a current design scheme and at least one candidate design that are corresponding to the first component, the operation indicator in the corresponding window points to the candidate design, and the processor is further configured to instantly apply a formula and parameters of the candidate design scheme to the object, in order to run a simulation of the object and provide a preview display of the simulation.

In some embodiments, wherein the first design specification comprises a current design scheme and at least one candidate design that are corresponding to the first component, the corresponding window receives a command that is for switching from the current design scheme to the candidate design scheme, and the first component is adjusted in the design screen to meet the candidate design scheme.

In summary, the synchronous operation display system provided by the embodiments of the present disclosure allows the user to conveniently design and save unnecessary manual operation time.

### BRIEF DESCRIPTION OF THE DRAWINGS

FIG. 1 shows a schematic diagram of a synchronous operation display system according to some embodiments of the present disclosure.

FIG. 2 shows a schematic diagram of a mediation program according to some embodiments of the present disclosure.

FIG. 3 shows a schematic diagram of a synchronous operation display interface according to some embodiments of the present disclosure.

FIG. 4 shows a flow chart of a control method according to some embodiments of the present disclosure.

### DETAILED DESCRIPTION

All terms used in this disclosure have their ordinary meanings. The above vocabulary is defined in the commonly used dictionary, and any examples of the use of the vocabulary discussed herein are included in the description of the specification, and are not intended to limit the scope and meaning of the disclosure. As such, the present disclosure is not limited to the various embodiments shown in this specification.

As used herein, “coupled” or “connected” may mean that two or more elements are in direct physical or electrical contact with each other, or indirectly in physical or electrical contact with each other. It can also mean that two or more components operate or act on each other.

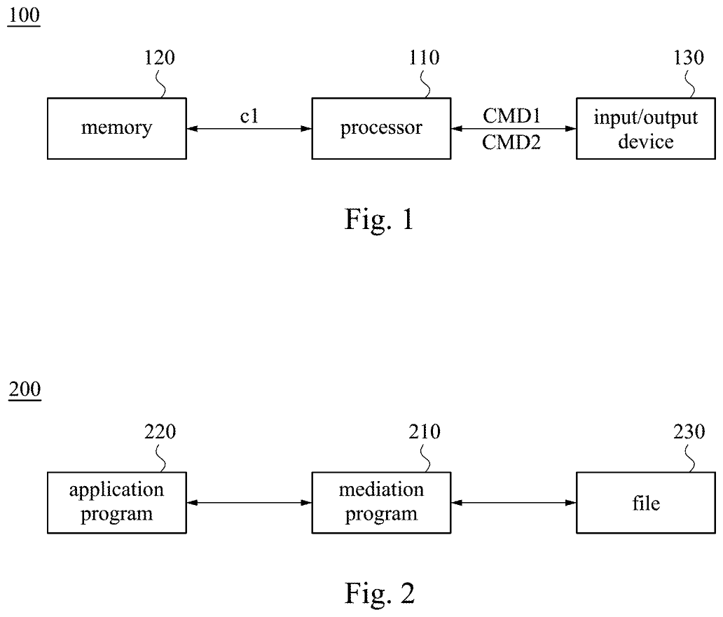

Referring to FIG. 1, FIG. 1 is a schematic diagram of a synchronous operation display system 100 according to some embodiments of the present disclosure. In different applications, the synchronous operation display system 100 can be a device (e.g., personal computer, tablet computer, mobile phone, notebook computer, electronic whiteboard, etc.). For example, the synchronous operation display system 100 can be an electronic whiteboard for teaching applications.

The synchronous operation display system 100 includes a processor 110, a memory 120, and an input/output device 130. The processor 110 is coupled to the memory 120 and the input/output device 130. In some embodiments, processor 110 is a central processing unit (CPU), an application-specific integrated circuit (ASIC), a multi-processor, a decentralized processing system, or a suitable processing unit.

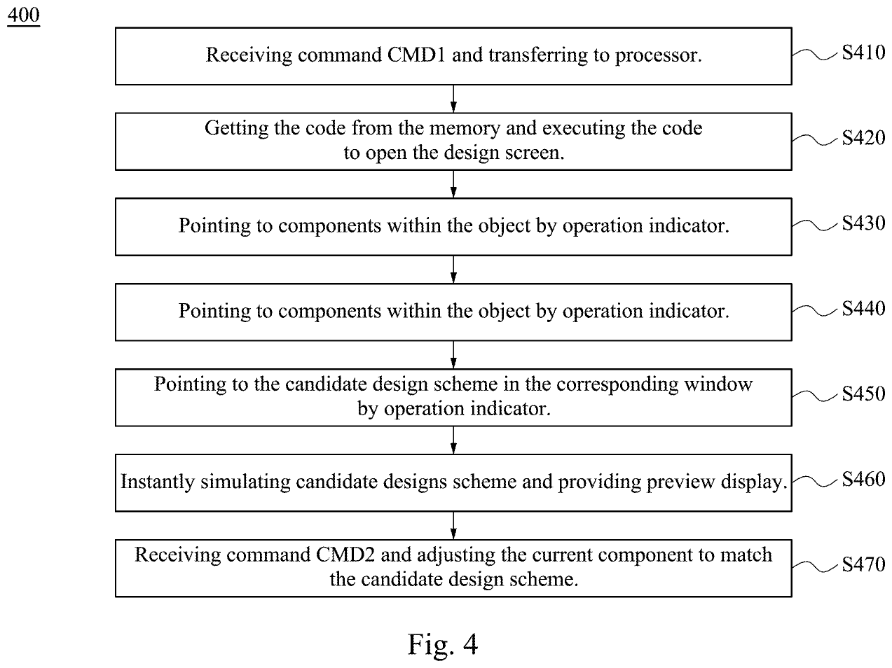

The memory 120 stores a computer program code C1 for implementing a application software of the synchronous operation display system 100. For example, the memory 120 stores a computer program code C1 for providing functions for synchronous operation display system 100 (e.g., mechanism design, circuit design, drawing, teaching applications, etc.). In some embodiments, the at least one computer program code C1 can be encoded by a plurality of instruction sets to perform a plurality of operations including FIG. 4 described later. The processor 110 can execute the computer program code C1, and a plurality of operations on the application program 220 and the mediation program 210 (as shown in FIG. 2) can be automatically executed.

In some embodiments, the memory 120 is non-transitory computer readable media storage medium. In some embodiments, the computer readable storage medium is an electrical, magnetic, optical, infrared, and/or semiconductor system (or apparatus or device). For example, computer readable storage media includes semiconductor or solid state memory, magnetic tape, removable computer disk, random access memory (RAM), read only memory (ROM), hard disk and/or optical disk. In one or more embodiments using an optical disk, the computer readable storage medium comprises a CD-ROM, a CD-R/W, and/or a digital video disk (DVD).

In some embodiments, the screen 320 displays a picture based on the control of the processor 110, and this picture contains multiple windows. In some embodiments, the synchronous operation display system 100 can further include circuit components including a display card (not shown) or a video processing circuit (not shown). The above circuit components can provide processed image data to the screen 320 for display based on the control of the processor 110.

In some embodiments, the screen 320 can be a touch screen that can be controlled by a user. The user can input an command CMD1 or CMD2 from the screen 320, and the processor 110 can perform an operation according to the command CMD1 or CMD2 (for example, the operation of FIG. 4 described later).

In some embodiments, the synchronous operation display system 100 can also cooperate with other input/output devices (not shown) to receive the aforementioned command CMD1 or CMD2. In some embodiments, the input/output device 130 includes a keyboard, a numeric keypad, a screen, a touch screen, a mouse, a trackball, a cursor direction key, a remote controller, or a combination thereof to communicate information and commands to the processor 110. The above manner of inputting the command CMD1 or CMD2 is used as an example, and various manners of inputting commands CMD1 or CMD2 are within the contemplated scope of the present disclosure.

In order to facilitate descriptions of a control method 400 of FIG. 4, various related terms or elements will be described with reference to FIGS. 1 to 3 in sequence.

FIG. 2 is a schematic diagram of a mediation program diagram 200 according to some embodiments of the present disclosure. The mediation program 210 is software between operating system and execution application program 220 that operated in the operating system. The mediation program 210 allows the distributed application program 220 to perform communication and data management. The mediation program 210 can connect the two programs together, so that the data and the database can be passed and connected to each other. In this case, the mediation program 210 is used to implement the synchronous operation display control method 400, in order to connect the application program 220 with the file 230.

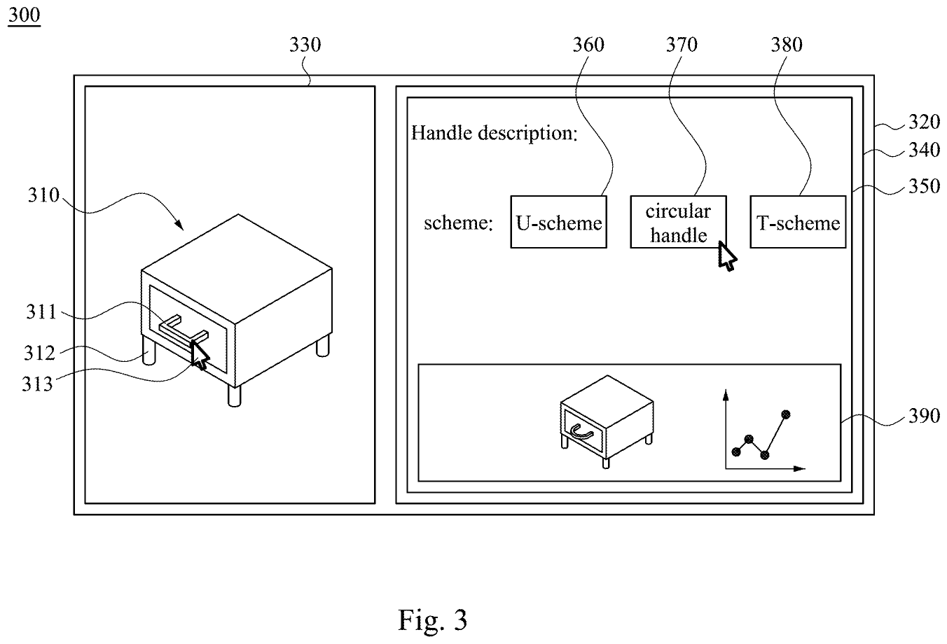

FIG. 3 is a schematic diagram of a synchronous operation display interface 300 that is displayed by the input/output device 130 of FIG. 1, according to some embodiments of the present disclosure. As shown in FIG. 3, the input/output device 130 in FIG. 1 can be implemented by a screen 320. The picture presented on a screen 320 includes the design screen 330 and a corresponding window 340. In this embodiment, the application program 220 is a design software (e.g., AutoCad, CarolDraw, HSPICE, etc.) for planning or designing specific objects. When the application program 220 is launched, the design screen 330 of the application program 220 is opened, and the user can draw, change, adjust, or set the appearance, parameters, shape, or material of the object 310 via the design screen 330.

In the embodiment of FIG. 3, the object 310 is a movable locker, and the object 310 includes a first component 311 and a second component 312. In the embodiment of FIG. 3, the first component 311 is a handle of a drawer of an object 310, and the second component 312 is a moving pulley of the object 310. The removable locker, the handle and the moving pulley in the embodiment of FIG. 3 are merely illustrative, in order to facilitate understanding of the present disclosure, but the object 310 of the present disclosure and its components are not limited thereto. In other embodiments, the object 310 can be an electronic circuit, a semiconductor layout, a power machine, a building composition, a traffic plan, or other corresponding design. The components in the object 310 can also be corresponding electronic components, semiconductor structures, mechanical components, building units, roads, slogans, or other elements.

Referring to FIG. 3, when the screen 320 receives the command CMD1, the application program 220 is launched and the design screen 330 is provided. The picture shown by the design screen 330 includes the first component 311 and the second component 312 of the object 310 to be designed, and both the first component 311 and the second component 312 are required to meet corresponding design specifications.

In some embodiments, the design specification includes a first design specification and a second design specification.

When the user is designing the object 310, a particular component in the object 310 may be selected. For example, in the embodiment of FIG. 3, if the user selects the first component 311 (e.g., by moving the operation indicator 313 to a position of the first component 311), the corresponding window 340 is used to present the design specification 350 associated with the first component 311.

In some embodiments, the design specification 350 displays a corresponding first design specification or second design specification, including a plurality of chapters and pages, according to the relevant field of the current component.

The design specification 350 describes the specific design requirements and design rules of the object 310. The design specification 350 contains an overall technical description, functional and usage descriptions, constraints and appearance descriptions, and provides some design options to facilitate design needs.

In some embodiments, when the operation indicator 313 is adjacent to the first component 311 in the design screen 330, the corresponding window 340 is displayed. The corresponding window 340 displays a corresponding design specification 350.

In some embodiments, design specification 350 includes current design scheme 360, a first candidate design scheme 370, and a second candidate design scheme 380, and a preview display 390.

In the embodiment of FIG. 3, the design scheme has a current design scheme 360, the first candidate design scheme 370, and the second candidate design scheme 380, which are various specifications of the selected components. For example, in the embodiment of FIG. 3, the operation indicator 313 is located at the position of the first component 311 that is a handle device, and various solutions, such as a U-shaped handle, a circular handle, and a T-shaped handle are listed in the design specification 350.

In some embodiments, the operation indicator 313 is directed to the first candidate design scheme 370 in the corresponding window 340. The synchronous operation display system 100 will apply formula(s) and parameter(s) of the first candidate design scheme 370 to the first component 311 of the current object 310, and provide the preview display 390 via the corresponding window 340.

In the embodiment of FIG. 3, the first component 311 is a handle device, and the current design scheme 360 is a U-shaped handle. If the operation indicator 313 is located at the position of the circular handle of the first candidate design scheme 370, the preview display 390 provided in the corresponding window 340 will present a preview graphic of the object 310 being applied with the circular handle, and describe difference(s) between before and after the object is applied with the circular handle by a chart or graphic.

In some embodiments, the preview display 390 further contains graphics or charts.

In some embodiments, the corresponding window 340 receives the command CMD2 switched from the current design scheme to the first candidate design scheme 370, and the first component 311 is adjusted to meet the first candidate design scheme 370 in the design screen 330.

In the embodiment of FIG. 3, the current design scheme 360 is a

U-shaped handle, and the operation indicator 313 is located at the position of the circular handle of the first candidate design scheme 370. The preview display 390 is presented with an applied graphic. If a changing action is performed through the operation indicator 313, the first component 311 in the design screen 330 is adjusted from the U-shaped handle of the current design scheme 360 to the circular handle of the first candidate design scheme 370.

FIG. 4 is a flow chart of a control method 400 of a synchronous operation display system 100 according to some embodiments of the present disclosure. For ease of understanding, the control method 400 will be described with reference to the aforementioned synchronous operation display system 100 and the synchronous operation display interface 300. In some embodiments, the synchronous operation display interface 300 can be used in engineering or teaching applications to improve design convenience.

In operation S410, the input/output device 130 receives the command CMD1 and transmits the same to the processor 110.

In operation S420, the processor 110 obtains the computer program code C1 from the memory 120 and executes the computer program code C1, in order to launch the application program 220.

In operation S430, by controlling the input/output device 130, the operation indicator 313 is directed to the first component 311 of the object 310 in the design screen 330.

In operation S440, when the processor 110 detects that the operation indicator 313 is adjacent to the first component 311 in the design screen 330, the corresponding window 340 is displayed. The corresponding window 340 displays the design specification 350 corresponding to the current component.

In some embodiments, the design specification 350 includes a current design scheme 360 corresponding to the current component, the first candidate design scheme 370, the second candidate design scheme 380, and the preview display 390.

In operation S450, the operation indicator 313 is directed to first candidate design scheme 370 within the corresponding window 340.

In operation S460, when the operation indicator 313 is directed to the first candidate design scheme 370, the processor 110 performs a simulation to apply the formula and parameters of the first candidate design scheme 370 to the first component 311, and provides the preview display 390.

In some embodiments, the preview display 390 presents the difference between before and after the current component is applied with the first candidate design scheme 370.

In operation S470, the corresponding window 340 receives the command CMD2 for switching to the first candidate design scheme 370. The first component 311 is adjusted in the design screen 330 to meet the specifications of the first candidate design scheme 370.

In some embodiments, the foregoing descriptions are given with examples where operations are performed with the first component 311. It is noted that the same operations can be performed with the second component 312.

In some embodiments, the object 301 including the first component 311 and the second component 312 are given for ease of understanding and for illustrative purposes, and the number of components is not limited thereto.

As discussed in the related arts, when making the design via the application program 220, it is necessary to refer to the relevant document manual, design parameters or methods application program 220 for product design, resulting in waste of time in flipping through files and queries. With the synchronous operation display system 100 and the control method 400, the embodiments of the present disclosure can improve this issue of the related art, in order to improve the operation convenience and efficiency of the engineering design.

The plurality of operations in the control method 400 of the synchronous operation display system 100 described above are merely examples. It is not limited to be performed in the order in this example. Various operations under control method 400 may be appropriately added, replaced, omitted, or performed in a different order, without departing from the scope of the embodiments of the present disclosure.

In some embodiments, the control method 400 can be implemented in accordance with a window management rule and/or a layer management rule of a kernel of a system platform to which the synchronous operation display system 100 is applied. In some embodiments, the aforementioned system platform can be an operating system. (e.g., Android, IOS, Linux, etc.) The above arrangement is used for example, and those skilled in the art can adjust the window and/or related instructions and parameters according to different system kernels and control methods 400.

In some embodiments, control method 400 can be implemented as an application on a non-transitory computer readable medium. In some embodiments, control method 400 can be implemented by hardware, software, firmware, or any combination of the above. For example, if speed and accuracy are the main considerations, they can be implemented mainly by hardware and/or firmware. If design flexibility is the main consideration, it can be mainly realized by software. The above implementation manner is only an example, and the present disclosure is not limited thereto.

In summary, the synchronous operation display system 100 provided by the embodiments of the present disclosure allows the user to conveniently design and save unnecessary manual operation time.

Although the present disclosure has been disclosed in the above embodiments, but it is not limited thereto. Anyone who is familiar with this skill can make various changes and refinements without departing from the spirit and scope of this disclosure. Therefore, the scope of protection of this disclosure is subject to the definition of the scope of the patent application attached.

What is claimed is:

1. A synchronous operation display system operating in at least one computer, the synchronous operation display system comprising:
at least one input/output device configured to display a picture and receive at least one command;
a memory configured to store at least one computer code, an application program, and a file; and
a processor coupled to the at least one input/output device and the memory, the processor configured to execute at least one computer code, in order to:
open the application program to provide a design screen of an object, wherein the design screen comprises a first component and a second component to be designed of the object, the first component is required to meet a first design specification, and the second component is required to meet a second design specification that is different from the first design specification;
display a corresponding window that displays the first design specification when an operation indicator is detected to be adjacent to the first component in the design screen; and
display the corresponding window that displays the second design specification when the operation indicator is detected to be adjacent to the second component in the design screen.

2. The synchronous operation display system of claim 1, wherein the first design specification comprises a current design scheme and at least one candidate design that are corresponding to the first component.

3. The synchronous operation display system of claim 2, wherein when the operation indicator in the corresponding window points to the candidate design, and the processor is further configured to instantly apply a formula and parameters of the candidate design scheme to the object, in order to run a simulation of the object and provide a preview display of the simulation.

4. The synchronous operation display system of claim 3, wherein the preview display presents changes between before and after the object is applied with the candidate design scheme by a graph or a chart.

5. The synchronous operation display system of claim 2, wherein when the corresponding window receives a command that is for switching from the current design scheme to the candidate design scheme, and the first component is adjusted in the design screen to meet the candidate design scheme.

6. The synchronous operation display system of claim 2, wherein the first design specification comprises a plurality of chapters and pages that illustrate the current design scheme and the candidate design scheme.

7. A non-transitory computer readable medium comprises a computer program instruction, when a processor executes the computer program instruction, causing the processor to perform the following operations:
open an application program for providing a design screen of an object, wherein the design screen comprises a first component and a second component to be designed of the object, the first component is required to meet a first design specification, and the second component is required to meet a second design specification that is different from the first design specification;
display a corresponding window that displays the second design specification when an operation indicator is detected to be adjacent to the first component in the design screen; and
display the corresponding window that displays the second design specification when the operation indicator is detected to be adjacent to the second component in the design screen.

8. The non-transitory computer readable medium of claim 7, wherein the first design specification comprises a current design scheme and at least one candidate design that are corresponding to the first component, the operation indicator in the corresponding window points to the candidate design, and the processor is further configured to instantly apply a formula and parameters of the candidate design scheme to the object, in order to run a simulation of the object and provide a preview display of the simulation.

9. The non-transitory computer readable medium of claim 7, wherein the first design specification comprises a current design scheme and at least one candidate design that are corresponding to the first component, the corresponding window receives a command that is for switching from the current design scheme to the candidate design scheme, and the first component is adjusted in the design screen to meet the candidate design scheme.
